(19) United States
(12) Patent Application Publication
(10) Pub. No.: US 2024/0160696 A1
(43) Pub. Date: May 16, 2024

(54) Method for Automatic Detection of Pair-Wise Interaction Effects Among Large Number of Variables

(71) Applicant: STATE FARM MUTUAL AUTOMOBILE INSURANCE COMPANY, Bloomington, IL (US)

(72) Inventors: Forrestt Severtson, Alpharetta, GA (US); Xuehong Sun, Normal, IL (US); Andrew Karl Pulkstenis, Mahomet, IL (US); Sandra Kane, Land O Lakes, FL (US)

(21) Appl. No.: 18/241,713

(22) Filed: Sep. 1, 2023

Related U.S. Application Data
(60) Provisional application No. 63/425,614, filed on Nov. 15, 2022.

(51) Int. Cl. G06F 18/2113; G06F 17/18

(52) U.S. Cl. CPC G06F 18/2113; G06F 17/18; G06F 18/27

(57) ABSTRACT

Techniques for automatically detecting pair-wise interaction effects among a large number of variables are provided. An example method includes obtaining a data set including data related to a target variable and each of a plurality of variables upon which the target variable depends; grouping the data related to each variable, of the plurality of variables, into a pre-determined number of groups of grouped variable values; analyzing the grouped variable values related to each variable as compared to the grouped variable values related to each other variable, of the plurality of variables, in order to determine a grouped variable interaction score for each pair of variables, of the plurality of variables; and identifying a pre-determined number of pairs of variables having the highest interaction scores, based on the grouped variable interaction score for each pair of variables.

### CROSS-REFERENCE TO RELATED APPLICATIONS

The present application claims priority to U.S. Provisional Application No. 63/425,614, file Nov. 15, 2022, and entitled “Method for automatic detection of pair-wise interaction effects among a large number of variables,” the entirety of which is incorporated by reference herein.

### FIELD OF THE DISCLOSURE

The present disclosure generally relates to technologies associated with statistical modeling and, more particularly, to technologies for automatically detecting pair-wise interaction effects among a large number of variables.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Interaction effects occur when the effect of one variable differs depending on the different value of another variable. Interaction effects are common in regression analysis, ANOVA, and designed experiments. When variables are preprocessed (for example, when the number of levels of a categorical variable is comprehensible, e.g., about 10), the interaction effects are usually examined manually. However, if there are one thousand variables, there will be about one million pair-wise interaction effects, which renders the manual examination infeasible. Thus, there is a need to address the problem of finding pair-wise interactions among a large number (e.g., greater than one thousand) of variables which are not preprocessed, for both linear regression and logistic regression models.

### SUMMARY

According to the present embodiments, techniques are provided for automatically detecting pair-wise interaction effects among a large number of variables.

In one aspect, a computer-implemented method for automatically detecting pair-wise interaction effects among a large number of variables is provided. The method may include obtaining, by one or more processors, a data set including data related to a target variable and each of a plurality of variables upon which the target variable depends; grouping, by the one or more processors, the data related to each variable, of the plurality of variables, into a pre-determined number of groups of grouped variable values; analyzing, by the one or more processors, the grouped variable values related to each variable as compared to the grouped variable values related to each other variable, of the plurality of variables, in order to determine a grouped variable interaction score for each pair of variables, of the plurality of variables; and identifying, by the one or more processors, a pre-determined number of pairs of variables having the highest interaction scores based on the grouped variable interaction score for each pair of variables.

In another aspect, a system for automatically detecting pair-wise interaction effects among a large number of variables is provided. The system may include one or more processors; and one or more memories storing instructions that, when executed by the one or more processors, cause the one or more processors to: obtain a data set including data related to a target variable and each of a plurality of variables upon which the target variable depends; group the data related to each variable, of the plurality of variables, into a pre-determined number of groups of grouped variable values; analyze the grouped variable values related to each variable as compared to the grouped variable values related to each other variable, of the plurality of variables, in order to determine a grouped variable interaction score for each pair of variables, of the plurality of variables; and identify a pre-determined number of pairs of variables having the highest interaction scores, based on the grouped variable interaction score for each pair of variables.

In still another aspect, a non-transitory computer-readable medium storing instructions for automatically detecting pair-wise interaction effects among a large number of variables is provided. The instructions, when executed by one or more processors, may cause the one or more processors to obtain a data set including data related to a target variable and each of a plurality of variables upon which the target variable depends; group the data related to each variable, of the plurality of variables, into a pre-determined number of groups of grouped variable values; analyze the grouped variable values related to each variable as compared to the grouped variable values related to each other variable, of the plurality of variables, in order to determine a grouped variable interaction score for each pair of variables, of the plurality of variables; and identify a pre-determined number of pairs of variables having the highest interaction scores, based on the grouped variable interaction score for each pair of variables.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts an exemplary computer system for automatically detecting pair-wise interaction effects among a large number of variables, according to one embodiment;

FIG. 2 depicts a flow diagrams of an exemplary computer-implemented method for automatically detecting pair-wise interaction effects among a large number of variables, according to one embodiment; and

FIG. 3 depicts an exemplary computing system for automatically detecting pair-wise interaction effects among a large number of variables in which the techniques described herein may be implemented, according to one embodiment.

While the systems and methods disclosed herein are susceptible of being embodied in many different forms, it is shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples. Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

Interaction effects occur when the effect of one independent variable on a target dependent variable differs depending on the value of another independent variable. Interaction effects are common in regression analysis, business insight analysis, and designed experiments. Generally speaking, interaction effects between two independent variables can be identified by plotting the two independent variables against the target variable. When creating data models, it is common at the beginning of an advanced analytic effort to receive extremely large amounts of data that needs to be evaluated before using the data can be used in a model. In particular, significant interaction effects between independent variables in the data must be identified in order to ensure that the model is accurate. It would be incredibly time consuming, if possible at all, to manually examine and analyze each pair of independent variables, especially when there are upwards of one thousand independent variables and the data is not preprocessed. Furthermore, even using a computer, this process would be prohibitively time- and processor-intensive. Currently, there are no existing techniques for identifying previously unknown pair-wise interactions between independent variables at this scale.

The techniques provided herein address the problem of finding pair-wise interactions among a large number of variables which are not preprocessed, making large scale interaction detection feasible. Given a dataset that includes a target variable and a large number of independent variables (typically more than a thousand), the techniques provided herein can evaluate, rank, and reduce pair-wise interactions among a large number of variables. Generally speaking, the techniques provided herein involve leveraging statistical hypothesis testing techniques, information theory, and software optimization.

In an example, an input includes a number “G,” which is called expected number of groups of values into which the data associated with each of the independent variables should be reduced (e.g., 20) and another number “K,” which is the final number (e.g., 100) of the most significant pair-wise interaction effects to keep, i.e., with the output including the t the “K” most significant pair-wise interaction effects.

Advantageously, in scenarios in which there are thousands of variables which are not preprocessed, the techniques provided herein may analyze both numeric and non-numeric independent variables in order to group the data associated with the variables into a set number of groups or bins, and using the grouped or binned variable values, identify less than one hundred (or any selected number) of the most significant pair-wise interaction effects. The techniques provided herein thus reduce the processing and memory requirements for both identifying pair-wise interaction effects, and subsequent analysis of those pair-wise interaction effects. That is, the computation time and computational intensity of identifying pair-wise interaction effects among one thousand independent variables may be reduced by analyzing the independent variables in order to group the data associated with the variables into a set number of groups or bins prior to identifying the pair-wise interaction effects between pairs of the variables. Furthermore, identifying a reduced number of pairs of variables having significant pair-wise interaction effects may reduce the computation time and computational intensity of subsequently analyzing those pair-wise interaction effects, or even enable subsequent manual analysis of the pair-wise interaction effects in some cases.

### Exemplary System for Automatically Detecting Pair-Wise Interaction Effects Among a Large Number of Variables

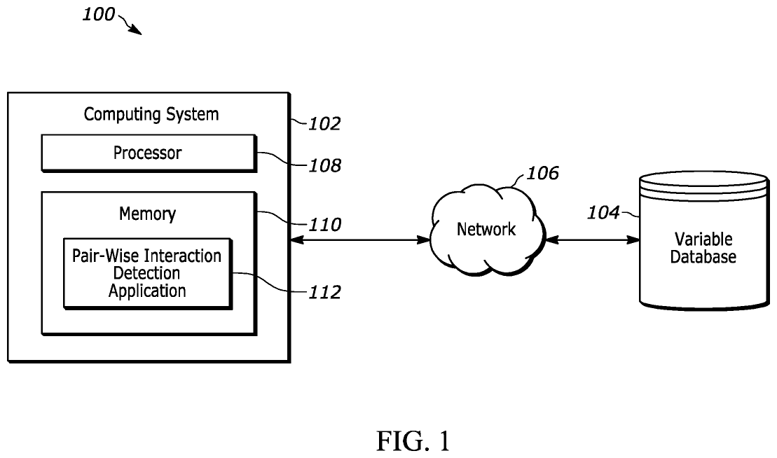

Referring now to the drawings, FIG. 1 depicts an exemplary system 100 for automatically detecting pair-wise interaction effects among a large number of variables, according to one embodiment. The high-level architecture illustrated in FIG. 1 may include both hardware and software applications, as well as various data communications channels for communicating data between the various hardware and software components, as is described below.

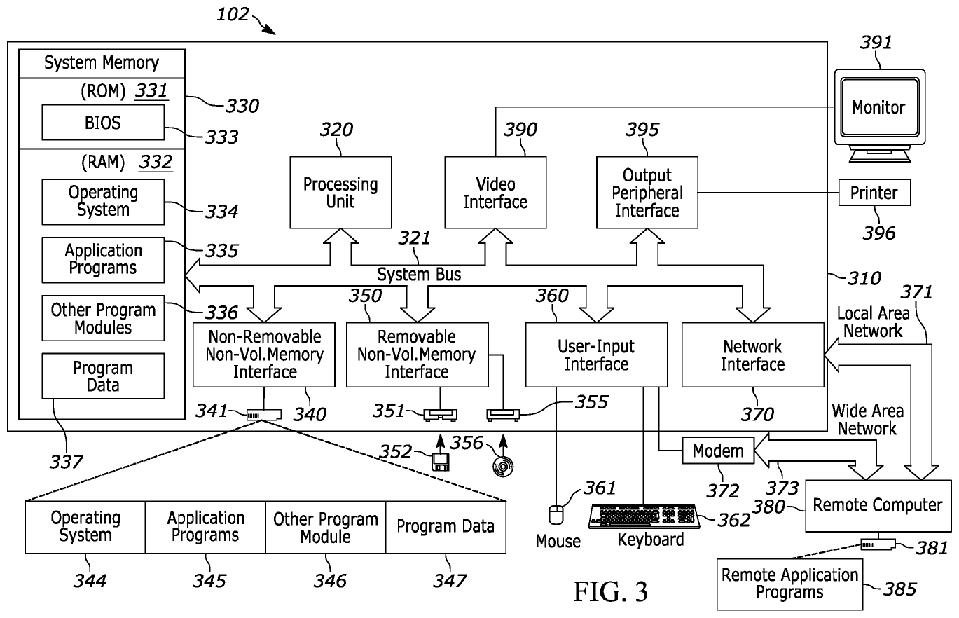

The system 100 may include a computing system 102, which is described in greater detail below with respect to FIG. 3, and one or more databases 104, e.g., configured to communicate with one another via a wired or wireless computer network 106. Although one computing system 102, one database 104, and one network 106 are shown in FIG. 1, any number of such computing systems 102, databases 104, and networks 106 may be included in various embodiments.

In some embodiments the computing system 102 may comprise one or more servers, which may comprise multiple, redundant, or replicated servers as part of a server farm. In still further aspects, such server(s) may be implemented as cloud-based servers, such as a cloud-based computing platform. For example, such server(s) may be any one or more cloud-based platform(s) such as MICROSOFT AZURE, AMAZON AWS, or the like. Such server(s) may include one or more processor(s) 108 (e.g., CPUs) as well as one or more computer memories 110.

Memories 110 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 110 may store an operating system (OS) (e.g., Microsoft Windows, Linux, UNIX, etc.) capable of facilitating the functionalities, apps, methods, or other software as discussed herein. Memorie(s) 110 may also store a pair-wise interaction detection application 112. Additionally, or alternatively, the memorie(s) 110 may store a dataset including a plurality of predictor variables associated with a target dependent variable, including independent variable values and associated dependent variable values. This dataset may also be stored in a variable database 104, which may be accessible or otherwise communicatively coupled to the computing system 102.

Executing the pair-wise interaction detection application 112 may include obtaining a data set including data related to a target variable and each of a plurality of independent variables (e.g., in some cases, upwards of one thousand variables) upon which the target variable depends, e.g., by retrieving or receiving the data set from the database 104. The target variable may be binary or continuous. For instance, the target variable may be a “yes”/“no” answer to a particular question, such as, “Did a vehicle collision occur?” As another example, the target variable may be a numerical value, such as a numerical value representing a number of vehicle collisions (e.g., an average number of vehicle collisions), a frequency of vehicle collisions (e.g., an average frequency of vehicle collisions), a severity of vehicle collisions (e.g., an average severity of vehicle collisions), a cost of repair for vehicle collisions (e.g., an average cost of repair for vehicle collisions), etc.

In some examples, the data related to the plurality of independent variables may be numeric data, while in other examples, the data related to the variables may be non-numeric data, or the data related to some of the variables may be numeric data while the data related to other of the variables may be non-numeric data. For instance, numeric data related to the plurality of independent variables may include, for example, data related to ages of vehicle drivers, data related to numbers of previous collisions for vehicle drivers, data related to zip codes of vehicle drivers, data related to costs of vehicles, data related to vehicle speed or acceleration values, data related to dates or times, etc. Non-numeric data related to the plurality of independent variables may include, for example, data related to states or countries where collisions occurred, data related to roads on which collisions occurred, data related to weather conditions, etc.

In any case, the pair-wise interaction detection application 112 may group the data related to each of the variables into a pre-determined number (“G”) of groups of grouped variable values. In some examples, the number of groups may be set by a user. For instance, a user may provide an input to the pair-wise interaction detection application 112 indicating that there should be 5 groups, or 10 groups, or 15 groups, or 20 groups, etc. In some examples, the groups may be “binned,” such that ranges of the independent variable are grouped together such that the pre-determined number of groups are formed.

The pair-wise interaction detection application 112 may use a function “GroupNumeric” in order to return a dataset with grouped numeric variables. In particular, the function “GroupNumeric” may sort the numeric independent variable values and try to divide the numeric independent variables into “G” groups. In some cases, there may not be exactly “G” groups due to the uneven size of each independent variable value. If the resulting number of groups is less than, a certain number (e.g., 4), “G” may be increased to “G*G” and the previous step may be repeated. After this, when each variable value belongs to a group, the function “GroupNumeric” may assign the independent variable value with the group number. For example, if the value of the independent variable belongs to group 2, then the independent variable may be assigned with a new value of 2. Accordingly, the function “GroupNumeric” may keep the new independent variable values and remove the old independent variable values.

For instance, the function “GroupNumeric” may return data related to ages of vehicle drivers grouped into groups of age ranges, such “group 1” including ages 16-20, “group 2” including ages 21-25, etc. Thus, an independent variable of age 17 may be changed to group 1, an independent variable of age 24 may be changed to group 2, etc. As another example, the function “GroupNumeric” may return data related to costs of vehicles grouped into groups of price ranges, such as “group 1” of 0-$5,000 vehicle cost, “group 2” of $5,000-$10,000 vehicle cost, “group 3” of $10,000-$15,000 vehicle cost, etc. Thus, an independent variable of cost $4,000 may be changed to group 1, an independent variable of cost $7,000 may be changed to group 2, an independent variable of cost $12,000 may be changed to group 3, etc.

In a similar manner, the pair-wise interaction detection application 112 may use a function “GroupNonNumeric” in order to return a dataset with grouped non-numeric variables. In particular, the function “GroupNonNumeric” may group the target variable values based on the independent variable values (levels). The function “GroupNonNumeric” may calculate the average target variable value for each level, and may sort the average target variable value and try to divide the average target variable value into “G” groups using the level size (number of records in each level) as weight. In some cases, there may not be exactly “G” groups due to the uneven level size. If the resulting number of groups is less than, a certain number (e.g., 4), “G” may be increased to “G*G” and the previous step may be repeated. After this, when each level belongs to a group, the function “GroupNonNumeric” may assign the independent variable value with the group number. For example, if the value of the independent variable belongs to group 2, then the independent variable may be assigned with a new value of 2. Accordingly, the function “GroupNonNumeric” may keep the new independent variable values and remove the old independent variable values.

As an example, the function “GroupNonNumeric” may return data related to states or countries where drivers live or where collisions occurred grouped into groups of several neighboring states, such as “group 1” of Midwestern states, “group 2” of Southeastern states, “group 3” of Pacific Northwest states, etc. Thus, an independent variable of Illinois may be changed to group 1, an independent variable of North Carolina may be changed to group 2, an independent variable of Oregon may be changed to group 3, etc. A larger pre-determined number of groups may result in smaller ranges, while a smaller pre-determined number of groups may result in larger ranges.

The pair-wise interaction detection application 112 may combine the dataset including the data related to the grouped numeric variables and the dataset including the data related to the grouped non-numeric variables. Furthermore, the pair-wise interaction detection application 112 may compare the grouped variable values related to each variable to the grouped variable values related to each other variable. The pair-wise interaction detection application 112 may analyze these comparisons in order to determine respective grouped variable interaction scores for each of the pairs of variables. For instance, in some examples, this determination may include running a regression analysis on the grouped variable values for the first variable of the pair against the grouped variable values for the second variable of the pair. The regression will produce a score, such as the probability of Chi-square, for the interaction term, which may be used as an interaction score. The interaction scores may be calculated using different methods in some cases. Moreover, in some examples, this analysis may include using a function “EvaluateInteraction” which produces sorted interaction scores for each of the pair-wise interactions between pairs of independent variables.

Using a dataset with a target variable and grouped independent variables, the function “EvaluateInteraction” may treat each new grouped independent variable as non-numeric variable, even if the original independent variable was a numeric variable. For each pair of independent variables, the grouped variables may be compared to one another in order to evaluate the pair-wise interaction effects between the grouped variables and generate an interaction score. The function “EvaluateInteraction” may sort the scores for each of the pair-wise interactions from most significant to least significant (i.e., from highest score to lowest score).

Using the sorted pair-wise interaction scores, the pair-wise interaction detection application 112 may identify a pre-determined number (“K”) of pairs of variables having significant interaction effects based on the grouped variable interaction score for each pair of variables (e.g., including the pairs of variables having the highest scores). In some examples, the number of pairs may be set by a user. For instance, a user may provide an input to the pair-wise interaction detection application 112 indicating that there should be 25 pairs, or 50 pairs, or 100 pairs, etc.

The pair-wise interaction detection application 112 may then perform additional analysis or processing on the data related to the identified pairs of variables having significant interaction effects, i.e., without performing additional analysis or processing on the data related to pairs of variables that are not identified as having significant interaction effects. In some examples, the data related to the identified pairs of variables having significant interaction effects may be written to a first file, while the data related to pairs of variables that are not identified as having significant interaction effects is written to a second file. The first file may be, e.g., analyzed further, or exported for further analysis.

In addition to the pair-wise interaction detection application 112, memories 110 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. It should be appreciated that one or more other applications may be envisioned and that are executed by the processor(s) 108. It should be appreciated that given the state of advancements of mobile computing devices, all of the processes functions and steps described herein may be present together on a mobile computing device (e.g., user computing device 104).

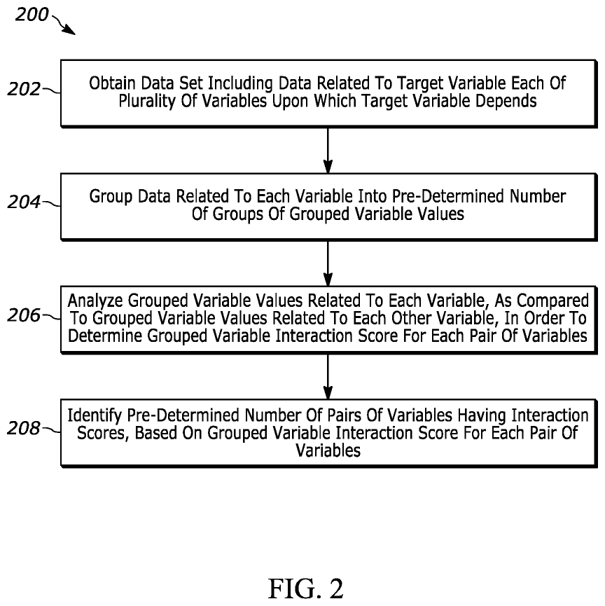

Furthermore, in some examples, the computer-readable instructions stored on the memory 110 may include instructions for carrying out any of the steps of the method 200 via an algorithm executing on the processors 108, which is described in greater detail below with respect to FIG. 2.

### Exemplary Computer-Implemented Method for Automatically Detecting Pair-Wise Interaction Effects Among a Large Number of Variables

FIG. 2 depicts a flow diagram of an exemplary computer-implemented method 200 for automatically detecting pair-wise interaction effects among a large number of variables, according to one embodiment. One or more steps of the method 200 may be implemented as a set of instructions stored on a computer-readable memory (e.g., memory 110) and executable on one or more processors (e.g., processor 108).

The method 200 may include obtaining (block 202) a data set including a target (i.e., dependent) variable and data related to each of a plurality of (e.g., independent) variables upon which the target variable depends. In some examples, the data set may include data from one thousand or more variables. For instance, the data related to the variables may be numeric data, in some examples. Additionally, the data related to the variables may be non-numeric data, in some examples. Furthermore, in some examples, the data related to some of the variables may be numeric data while the data related to other of the variables may be non-numeric data.

The data related to each variable, of the plurality of variables, may be grouped (block 204) into a pre-determined number of groups of grouped variable values. For instance, this pre-determined number of groups of grouped variable values may be set by a user.

The grouped variable values related to each variable as compared to the grouped variable values related to each other variable, of the plurality of variables, may be analyzed (block 206) in order to determine a grouped variable interaction score for each pair of variables, of the plurality of variables.

A pre-determined number of pairs of variables having the highest interaction scores may be identified (block 208) based on the grouped variable interaction score for each pair of variables. For instance, the pre-determined number of pairs of variables may be set by a user.

In some examples, the method 200 may further include performing additional analysis or processing on the data related to the identified pairs of variables having the highest interaction scores, i.e., without performing additional analysis or processing on the data related to pairs of variables that are not identified as having the highest interaction scores.

### Exemplary Computing System for Automatically Detecting Pair-Wise Interaction Effects Among a Large Number of Variables

FIG. 3 depicts an exemplary computing system 102 in which the techniques described herein may be implemented, according to one embodiment. The computing system 102 of FIG. 3 may include a computing device in the form of a computer 310. Components of the computer 310 may include, but are not limited to, a processing unit 320 (e.g., corresponding to the processor 120 of FIG. 1), a system memory 330 (e.g., corresponding to the memory 122 of FIG. 1), and a system bus 321 that couples various system components including the system memory 330 to the processing unit 320. The system bus 321 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 310 may include a variety of computer-readable media. Computer-readable media may be any available media that can be accessed by computer 310 and may include both volatile and nonvolatile media, and both removable and non-removable media. By way of example, and not limitation, computer-readable media may comprise computer storage media and communication media.

Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 330 may include computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to, and/or presently being operated on, by processing unit 320. By way of example, and not limitation, FIG. 3 illustrates operating system 334, application programs 335 (e.g., corresponding to the pair-wise interaction detection application 112 of FIG. 1), other program modules 336, and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 may be connected to the system bus 321 through a non-removable memory interface such as interface 340, and magnetic disk drive 351 and optical disk drive 355 may be connected to the system bus 321 by a removable memory interface, such as interface 350.

The drives and their associated computer storage media discussed above and illustrated in FIG. 3 provide storage of computer-readable instructions, data structures, program modules and other data for the computer 310. In FIG. 3, for example, hard disk drive 341 is illustrated as storing operating system 344, application programs 345, other program modules 346, and program data 347. Note that these components may either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as cursor control device 361 (e.g., a mouse, trackball, touch pad, etc.) and keyboard 362. A monitor 391 or other type of display device is also connected to the system bus 321 via an interface, such as a video interface 390. In addition to the monitor, computers may also include other peripheral output devices such as printer 396, which may be connected through an output peripheral interface 395.

The computer 310 may operate in a networked environment using logical connections to one or more remote computers, such as a remote computer 380. The remote computer 380 may be a mobile computing device, personal computer, a server, a router, a network PC, a peer device or other common network node, and may include many or all of the elements described above relative to the computer 310, although only a memory storage device 381 has been illustrated in FIG. 3. The logical connections depicted in FIG. 3 include a local area network (LAN) 371 and a wide area network (WAN) 373 (e.g., either or both of which may correspond to the network 106 of FIG. 1), but may also include other networks. Such networking environments are commonplace in hospitals, offices, enterprise-wide computer networks, intranets and the Internet.

When used in a LAN networking environment, the computer 310 is connected to the LAN 371 through a network interface or adapter 370. When used in a WAN networking environment, the computer 310 may include a modem 372 or other means for establishing communications over the WAN 373, such as the Internet. The modem 372, which may be internal or external, may be connected to the system bus 321 via the input interface 360, or other appropriate mechanism. The communications connections 370, 372, which allow the device to communicate with other devices, are an example of communication media, as discussed above. In a networked environment, program modules depicted relative to the computer 310, or portions thereof, may be stored in the remote memory storage device 381. By way of example, and not limitation, FIG. 3 illustrates remote application programs 385 as residing on memory device 381.

The techniques for automatically detecting pair-wise interaction effects among a large number of variables described above may be implemented in part or in their entirety within a computing system such as the computing system 102 illustrated in FIG. 3. In some such embodiments, the LAN 371 or the WAN 373 may be omitted. Application programs 335 and 345 may include a software application (e.g., a web-browser application) that is included in a user interface, for example.

### ADDITIONAL CONSIDERATIONS

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for automatically detecting pair-wise interaction effects among a large number of variables. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for automatically detecting pair-wise interaction effects among a large number of variables, comprising:
obtaining, by one or more processors, a data set including data related to a target variable and each of a plurality of variables upon which the target variable depends;
grouping, by the one or more processors, the data related to each variable, of the plurality of variables, into a pre-determined number of groups of grouped variable values;
analyzing, by the one or more processors, the grouped variable values related to each variable as compared to the grouped variable values related to each other variable, of the plurality of variables, in order to determine a grouped variable interaction score for each pair of variables, of the plurality of variables; and
identifying, by the one or more processors, a pre-determined number of pairs of variables having the highest interaction scores, based on the grouped variable interaction score for each pair of variables.

2. The computer-implemented method of claim 1, wherein the data related to one or more of the variables, of the plurality of variables, is numeric data.

3. The computer-implemented method of claim 1, wherein the data related to one or more of the variables, of the plurality of variables, is non-numeric data.

4. The computer-implemented method of claim 1, further comprising:
further analyzing, by the one or more processors, the data related to the identified pairs of variables having the highest interaction scores.

5. The computer-implemented method of claim 4, further comprising:
not further analyzing, by the one or more processors, the data related to pairs of variables not identified as having the highest interaction scores.

6. The computer-implemented method of claim 1, wherein one or more of the pre-determined number of groups of grouped variable values or the pre-determined number of pairs of variables having the highest interaction scores is set by a user.

7. The computer-implemented method of claim 1, wherein the plurality of variables includes greater than or equal to one thousand variables.

8. A system for automatically detecting pair-wise interaction effects among a large number of variables, comprising:
one or more processors; and
one or more memories storing instructions that, when executed by the one or more processors, cause the one or more processors to:
obtain a data set including data related to a target variable and each of a plurality of variables upon which the target variable depends;
group the data related to each variable, of the plurality of variables, into a pre-determined number of groups of grouped variable values;
analyze the grouped variable values related to each variable as compared to the grouped variable values related to each other variable, of the plurality of variables, in order to determine a grouped variable interaction score for each pair of variables, of the plurality of variables; and
identify a pre-determined number of pairs of variables having the highest interaction scores, based on the grouped variable interaction score for each pair of variables.

9. The system of claim 8, wherein the data related to one or more of the variables, of the plurality of variables, is numeric data.

10. The system of claim 8, wherein the data related to one or more of the variables, of the plurality of variables, is non-numeric data.

11. The system of claim 8, wherein the instructions, when executed by the one or more processors, further cause the one or more processors to:
further analyze the data related to the identified pairs of variables having the highest interaction scores.

12. The system of claim 11, wherein the instructions, when executed by the one or more processors, further cause the one or more processors to:
not further analyze the data related to pairs of variables not identified as having the highest interaction scores.

13. The system of claim 8, wherein one or more of the pre-determined number of groups of grouped variable values or the pre-determined number of pairs of variables having the highest interaction scores is set by a user.

14. The system of claim 8, wherein the plurality of variables includes greater than or equal to one thousand variables.

15. A non-transitory, computer-readable medium storing instructions for automatically detecting pair-wise interaction effects among a large number of variables that, when executed by one or more processors, cause the one or more processors to:
obtain a data set including data related to a target variable and each of a plurality of variables upon which the target variable depends;
group the data related to each variable, of the plurality of variables, into a pre-determined number of groups of grouped variable values;
analyze the grouped variable values related to each variable as compared to the grouped variable values related to each other variable, of the plurality of variables, in order to determine a grouped variable interaction score for each pair of variables, of the plurality of variables; and
identify a pre-determined number of pairs of variables having the highest interaction scores, based on the grouped variable interaction score for each pair of variables.

16. The non-transitory, computer-readable medium of claim 15, wherein the data related to one or more of the variables, of the plurality of variables, is numeric data.

17. The non-transitory, computer-readable medium of claim 15, wherein the data related to one or more of the variables, of the plurality of variables, is non-numeric data.

18. The non-transitory, computer-readable medium of claim 15, wherein the instructions, when executed by the one or more processors, further cause the one or more processors to:
further analyze the data related to the identified pairs of variables having the highest interaction scores.

19. The non-transitory, computer-readable medium of claim 18, wherein the instructions, when executed by the one or more processors, further cause the one or more processors to:
not further analyze the data related to pairs of variables not identified as having the highest interaction scores.

20. The non-transitory, computer-readable medium of claim 15, wherein one or more of the pre-determined number of groups of grouped variable values or the pre-determined number of pairs of variables having the highest interaction scores is set by a user.
